(19) United States
(12) Patent Application Publication
(10) Pub. No.: US 2024/0099304 A1
(43) Pub. Date: Mar. 28, 2024

(54) SYNERGISTIC HERBICIDAL COMPOSITIONS OF METAMIFOP

(71) Applicant: Parijat Industries (India) Private Limited, Dalhi (IN)

(72) Inventors: Shivraj ANAND, New Delhi (IN); Uday ANAND, New Delhi (IN); Sarvind DHIMAN, New Delhi (IN)

(21) Appl. No.: 18/267,353

(22) PCT Filed: Feb. 15, 2022
(86) PCT No.: PCT/IB2022/051323

§ 371 Date: Jun. 14, 2023

(30) Foreign Application Priority Data
Feb. 16, 2021 (IN) 202111006475

(51) Int. Cl. A01N 43/76; A01N 25/04; A01N 25/30; A01N 43/50; A01P 13/00

(52) U.S. Cl. CPC A01N 43/76; A01N 25/04; A01N 25/30; A01N 43/50; A01P 13/00

(57) ABSTRACT

The present invention provides a synergistic herbicidal composition for controlling undesired vegetation including broad leaf weeds and grasses comprising metamifop, imazethapyr and/or imazamox salts and/or combination thereof.

### FIELD OF THE DISCLOSURE

The present disclosure generally relates to herbicidal combination for controlling undesirable vegetation. More particularly, the present disclosure relates to synergistic combinations of metamifop with members of Imidazoline family for controlling a wide spectrum of weeds, process of preparing the compositions and methods of controlling the undesired vegetation thereof.

### BACKGROUND OF THE DISCLOSURE

The crops growing in the farmlands or the vegetation requires proper monitoring with regard to the aspects of pests and undesired vegetation commonly called as “weeds”, for better efficient yield of the crops. The weeds particularly have no taxonomical importance or botanical significance because the weeds are also a plant that in one context is significantly not considered as the weed when it is voluntarily grown. Thus, it may be noted that as the weed grows aggressively, it affects the nutrient present in the soil and competes with the main crop plant for various nutritional requirements. Thus, weed control is very crucial for agriculture. Weed control is the process of limiting weed infestations so the main crop plants could be grown profitably and other activities of man conducted efficiently. The main aim of weed control is to manage the vegetation on land and water bodies in such a way as will encourage the growth of plants beneficial to humans like the crops and will suppress the remaining unwanted plants. There are many methods to control the growth of weeds including but not limited to hand cultivation with hoes, powdered cultivation with cultivators, burning or chemical impacts etc.

With the ever-growing population and food requirements, it is a mandatory requirement to control the growth of weeds by methods which are economical and less time consuming for excellent yield of the main crop. One such chemical method involves the use of herbicides in the fields. However, most of such herbicide compositions have a range of harmful side effects including but not limited to phytotoxic effects, leaf cupping, crinckling, speckling, distorted leaves, color changes in leaves, stems, bark from green to light yellow to dark brown to the main crop plants. Thus, it may be noted that the main effect of the use of these herbicides is on the chlorophyll content of the plants and its synthesis process called as Photosynthesis. This leads to the death of the crop plants.

Current practices include combining herbicides that have different modes of action, however, these combinations do not effectively handle resistant, persistent weeds and yet do exert harmful effects on the main crop plants.

Soybean known as Glycine max L. Merr, belongs to the Fabaceae family, is the major Oilseed produced and consumed in the world. It has the highest protein content (40-42%), 20 percent oil, rich in lysine and vitamins A, B and D, also rich source of minerals and essential amino acids (Jadhav, 2014). Currently, India ranks fourth in respect to the acreage of soybean in the world, but production is half of the world's average. One of the major challenges in soybean production faced by Soybean farmers is the control of weeds which can cause significant yield loss. The undesirable competition includes broad leaf weeds and grasses. Several herbicides are in use for controlling weeds associated in soybean, but these have not been found much effective in controlling all sort of hard to control weeds. Therefore, it is imperative to evaluate the efficacy of suitable postemergence herbicides alone and in mixture for effective control of hard to control weed flora in soybean fields.

Imidazolinone group is very much used and effective herbicide for controlling some grassy and broad leaf weeds in soybean, however its efficacy has not been tested with Metamifop for wide spectrum weed control in soybean in various parts of the country.

In view of the above limitations of the conventional approaches, compositions and methods, there exists a need to develop an improved approach, compositions and method which would in turn address a variety of issues including, but not limited to less phytotoxicity to main crop plants, enhanced efficacy and broader spectrum of weed control including broad leaf weeds and grasses while being compatible with the main crop. Also, there is a need to develop a synergistic composition of herbicides which provides longer duration of control over resistant weeds and hard to control weeds grown with the crops of the Leguminous or Fabaceae family.

Thus, the above-described deficiencies of conventional approaches and compositions thereof, are merely intended to provide an overview of some of the problems of conventional approaches and are not intended to be exhaustive. Other problems with conventional approaches, and compositions and their corresponding benefits of the various non-limiting embodiments described herein may become further apparent upon review of the following description.

### SUMMARY OF THE INVENTION

The following presents a simplified summary of the invention to provide a basic understanding of some aspects of the invention. This summary is not an extensive overview of the present invention. It is not intended to identify the key/critical elements of the invention or to delineate the scope of the invention. Its sole purpose is to present some concept of the invention in a simplified form as a prelude to a more detailed description of the invention presented later.

It is, therefore, an object of the present invention to provide a synergistic herbicidal combination.

It is another object of the present invention to provide a composition comprising a synergistic herbicidal combination capable to control the undesired vegetation during the growth of crops of Leguminous or Fabaceae family

It is another object of the present invention to provide a synergistic herbicidal composition which offers a broader and more complete spectrum of weed control including broad leaf weeds and grasses.

It is another object of the present invention to provide a synergistic herbicidal composition which provides less phytotoxicity to main crop plants, enhanced efficacy and broader spectrum of weed control.

It is another object of the present invention to provide a method of controlling undesired vegetation at a locus by application of a synergistic herbicidal combination.

It is another object of the present invention to provide a method of increasing yield in a crop by application of a synergistic herbicidal combination.

It is another object of the present invention to provide a method of improving the plant health by application of a synergistic herbicidal combination.

Accordingly, in an aspect, the present invention provides a herbicidal composition comprising i) Metamifop; ii) at least a member of Imidazoline family and iii) agriculturally acceptable adjuvants. The at least a member of Imidazoline family is selected from imazethapyr and its derivatives or imazamox and its derivatives or both of them in combination thereof.

In one aspect, the present invention provides a composition comprising Metamifop and its derivatives and/or imazethapyr and its derivatives and/or imazamox and its derivatives.

In another aspect, the present invention provides a method of combating and controlling weeds at a locus by treating the locus with a combination composition comprising Metamifop and its derivatives and/or imazethapyr and its derivatives and/or imazamox and its derivatives.

Other aspects, advantages, and salient features of the invention will become apparent to those skilled in the art from the following detailed description, which, details the invention in different embodiments.

### DETAILED DESCRIPTION OF THE INVENTION

The exemplary mode for carrying out the disclosure is presented in terms of its exemplary embodiments. However, the exemplary embodiments described herein detail for illustrative purposes and are subject to many variations. It is understood that various omissions and substitutions of equivalents are contemplated as circumstances may suggest or render expedient, but are intended to cover the application or implementation without departing from the spirit or scope of the present disclosure.

The terms “a” and “an” herein do not denote a limitation of quantity, but rather denote the presence of at least one of the referenced item.

The term “herbicide”, as used herein, shall mean an active ingredient that kills, controls or otherwise adversely modifies the growth of plants. As used herein, a herbicidally effective or vegetation controlling amount is an amount of active ingredient that causes a “herbicidal effect,” i.e., an adversely modifying effect and includes deviations from natural development, killing, regulation, desiccation, retardation.

The terms “plants” and “vegetation” include, but are not limited to, germinant seeds, emerging seedlings, plants emerging from vegetative propagules, and established vegetation.

The term “locus” as used herein shall denote the vicinity of a desired crop in which weed control, typically selective weed control is desired. The locus includes the vicinity of desired crop plants wherein the weed infestation has either emerged or is yet to emerge. The term crop shall include a multitude of desired crop plants or an individual crop plant growing at a locus.

As used herein the term “agriculturally acceptable carrier” means carriers of which are known and accepted in the art for the formation of formulations for agricultural or horticultural use.

The term “surfactant,” as used herein, refers to an agriculturally acceptable material which imparts emulsifiability, stability, spreading, wetting, dispersibility or other surface-modifying properties.

Surprisingly, it has been found by the present inventors that the combination of Metamifop and at least a member of Imidazolinone family results in a synergistic control of wide spectrum of undesired vegetation/weeds at the locus of the desirable main crop plant with minimum or no harmful effect on main crop plants.

An aspect of the present invention is a herbicidal combination comprising (a) Metamifop; (b) at a member of Imidazolinone family.

In an embodiment of the present invention is provided a composition of (a) Metamifop; (b) a member of Imidazolinone family along with at least one agrochemically acceptable excipient.

In an embodiment of the present invention, the weight ratio of Metamifop and the member of Imidazolinone family are within the range from 2:80 to 80:2. In a specific embodiment, the weight ratio of Metamifop and the member of Imidazolinone family may be 2:0.1; preferably, in the ratio 1:1.

In a specific embodiment, the weight ratio of Metamifop:Imazethapyr:Imazamox is 8:4:3.

In an embodiment of the present invention, percentage amount of Metamifop is 2 to 80% of the total weight of the composition.

In an embodiment of the present invention, the at least a member of Imidazoline family is present in an amount ranging from 0.1 to 80% w/w based on the total weight of the composition.

Another aspect of the present disclosure is a method of controlling or combatting weeds at a locus, the method comprising applying, to the locus, a combination comprising (a) Metamifop; (b) a member of Imidazolinone family.

Each of the aspect described above may have one or more embodiments.

Metamifop is a member from aryloxyphenoxypropionate herbicides act by inhibiting the enzyme acetyl-CoA carboxylase (ACCase) in the chloroplasts of sensitive plants.

Members of the Imazolininone family act by inhibiting the ALS production, thus inhibits the protein synthesis in the growing tips of plants. Imidazolinone group is very much used and effective herbicide for controlling some grassy and broad leaf weeds in soybean, however its efficacy has not been tested with Metamifop for wide spectrum weed control in soybean in various parts of the country. Therefore, these studies were conducted to observe the weed controlling activity of the combination of Metamifop and Imidazolinone group herbicides. When compared the observed efficacy with the expected efficacy it was found that imidazolinone herbicides showed exceptional synergy when combined with Metamifop. Any difference between the observed and expected efficacy could be attributed to synergy between the compounds in the control of a broad spectrum of weeds. The expected efficacy of a combination of Metamifop and imidazolinone group herbicide was calculated using the well-established Colby method.

As described in the Herbicide Handbook of the Weed Science Society of America, Ninth Edition, 2007, p. 429, “synergism” [is] an interaction of two or more factors such that the effect when combined is greater than the predicted effect based on the response to each factor applied separately. In the Colby method, the expected (or predicted) response of a combination of herbicides is calculated by taking the product of the observed response for each individual component of the combination when applied alone divided by 100 and subtracting this value from the sum of the observed response for each component while applied alone. An unexpected enhancement in efficacy of the combination is then determined by comparing the observed response of the combination to the expected (or predicted) response as calculated from the observed response of each individual component alone. If the observed response of the combination is greater than the expected (or predicted) response, or stated conversely, if the difference between the observed and expected response is greater than zero, then the combination is said to be synergistic or unexpectedly effective. (Colby, S. R., Weeds, 1967(15), p. 20-22). The Colby method required only a single dose of each herbicide applied alone and the mixture of both doses.

Synergy Study: The following formula was used to calculate the expected activity of mixtures containing active ingredients, A and B:

$$Expected ( E ) = A + B - \frac{AB}{100}$$

### Where

A=Observed efficacy of active ingredient (combination of Metamifop and Imidazolinone herbicides) A at the same concentration as used in the mixture.
B=observed efficacy of active ingredient B at the same concentration as used in the mixture.
   However, following formula was used to calculate the expected activity of mixtures containing three active ingredients, A, B and C:

$$Expected ( E ) = A + B + C - \frac{AB + AC + BC}{100} + \frac{ABC}{10 , 000}$$

### Where

A=observed efficacy of active ingredient (combination of Metamifop and Imidazolinone herbicides) A at the same concentration as used in the mixture.
B=observed efficacy of active ingredient B at the same concentration as used in the mixture.
C=observed efficacy of active ingredient C at the same concentration as used in the mixture.

In an embodiment of the present invention, the synergistic combination is used for crops of the Leguminosae or Fabaceae family. The crops include but not limited to Soybean, Lucerne, Black gram, Groundnut, Green gram, Chickpea, Adzuki Beans, Red gram or pigeon pea and Cluster bean.

In an embodiment of the present invention, the undesired vegetation may be selected from the group consisting of echinochloa colona, dinebra arabica, cynotis sp, Eleusine indica, euphorbia hirta, Amaranthus viridis, digeria arvensis, digera sp., panicum sp., phyllanthus sp, Commelina benghalensis L, parthenium, trianthema portulacasturm, cleome viscosa, Digera arvensis, parthenium hysterophorus, cynadon dactylone, commelina bengalensis and dinebra sp., portulaca sp., trianthima sp., dactyloctenium aegyptium, corchprus sp., trianthema monogyna, brachiaria sp., echinochloa crusgalli, brachiaria euriciformis, rottboellia cochinchinensis, parthenium hyterophorus, cynotis axillaris, acalypha indica, celosia argentia, cyperus spp.

In an embodiment of the present invention, the member of Imidazolinone family is selected from, but not limited to, imazamethabenz-methyl, imazapyr, imazapic, imazethapyr, imazamox, imazaquin and their salts and esters.

In one of the exemplary embodiments of the present invention, the imazethapyr includes the free acid as well as agriculturally acceptable salts thereof.

Examples of agriculturally acceptable salts of imazethapyr include alkaline or earth alkaline metals or ammonium or organoammonium salts, for instance, sodium, potassium, ammonium and isopropyl ammonium. Particularly preferred is imazethapyr ammonium salt. Reference to a salt includes the anhydrous form as well as hydrated forms thereof.

In one of the exemplary embodiments of the present invention, the imazamox includes the free acid as well as agriculturally acceptable salts thereof.

Examples of agriculturally acceptable salts of imazamox include alkaline or earth alkaline metals or ammonium or organoammonium salts, for instance, sodium, potassium, ammonium and isopropyl ammonium. Particularly preferred is imazamox ammonium salt. Reference to a salt includes the anhydrous form as well as hydrated forms thereof.

In an embodiment of the present invention, the combination of the present invention may be combined with a herbicide. Exemplary herbicides that may be combined with the combination of the present invention may be selected from, but not limited to, herbicides belonging to classes such as ACCase inhibitors, ALS inhibitors, EPSP synthase inhibitors, synthetic auxins, auxin transport inhibitors, HPPD inhibitors, lipid synthesis inhibitors, long chain fatty acid inhibitors, as well as herbicides with unknown modes of action.

In an embodiment, the composition of the present invention may contain agriculturally acceptable adjuvants, carriers, diluents, emulsifiers, fillers, anti-foaming agents, thickening agents, anti-freezing agents, freezing agents etc. The compositions may be either solid or liquids. They can be solids, such as, for example, dusts, granules, water-dispersible granules, microcapsules or wettable powders, or liquids, such as, for example, emulsifiable concentrates, solutions, emulsions or suspensions, DC, ZC formulations. They can also be provided as a pre-mix or tank mixes.

The compositions may include additional other crop protection agents, for example pesticides, safeners or agents for controlling phytopathogenic fungi or bacteria.

In an exemplary embodiment of the present invention, the composition may be formulated in any form but not limited to OIL-IN-Water Emulsion, Microemulsion, Water-in-oil Emulsion, Emulsifiable Concentrate and WG formulation.

Suitable agricultural adjuvants and carriers may include, but are not limited to, crop oil concentrates; methylated seed oils, emulsified methylated seed oil, nonylphenol ethoxylate; benzylcocoalkyldimethyl quaternary ammonium salt; blend of petroleum hydrocarbon, alkyl esters, organic acid, and anionic surfactant; C9-C11 alkylpolyglycoside; phosphated alcohol ethoxylate; natural primary alcohol (C12-C16) ethoxylate; di-secbutylphenol EO-PO block copolymer; polysiloxane-methyl cap; nonylphenol ethoxylate, urea ammonium nitrate; tridecyl alcohol (synthetic) ethoxylate (8EO); tallow amine ethoxylate; PEG(400) dioleate-99, alkyl sulfates, such as diethanolammonium lauryl sulfate; alkylarylsulfonate salts, such as calcium dodecylbenzenesulfonate; alkylphenolalkylene oxide addition products, such as nonylphenol-C18 ethoxylate; alcohol-alkylene oxide addition products, such as tridecyl alcohol-C16 ethoxylate; soaps, such as sodium stearate; alkyl-naphthalene-sulfonate salts, such as sodium dibutylnaphthalenesulfonate; dialkyl esters of sulfosuccinate salts, such as sodium di(2-ethylhexyl)sulfosuccinate; sorbitol esters, such as sorbitol oleate; quaternary amines, such as lauryl trimethylammonium chloride; polyethylene glycol esters of fatty acids, such as polyethylene glycol stearate; block copolymers of ethylene oxide and propylene oxide; salts of mono and dialkyl phosphate esters; vegetable or seed oils such as soybean oil, rapeseed/canola oil, olive oil, castor oil, sunflower seed oil, coconut oil, corn oil, cottonseed oil, linseed oil, palm oil, peanut oil, safflower oil, sesame oil, tung oil and the like; and esters of the above vegetable oils, and in certain embodiments, methyl esters.

Suitable liquid carriers that may be employed in a composition of the present invention may include water or organic solvents. The organic solvents include, but are not limited to, petroleum fractions or hydrocarbons such as mineral oil, aromatic solvents, paraffinic oils, and the like; vegetable oils such as soybean oil, rapeseed oil, olive oil, castor oil, sunflower seed oil, coconut oil, corn oil, cottonseed oil, linseed oil, palm oil, peanut oil, safflower oil, sesame oil, tung oil and the like; esters of the above vegetable oils; esters of monoalcohols or dihydric, trihydric, or other lower polyalcohols (4-6 hydroxy containing), such as 2-ethyl hexyl stearate, n-butyl oleate, isopropyl myristate, propylene glycol dioleate, di-octyl succinate, di-butyl adipate, di-octyl phthalate and the like; esters of mono, di and polycarboxylic acids and the like. Organic solvents include, but are not limited to toluene, xylene, petroleum naphtha, crop oil, acetone, methyl ethyl ketone, cyclohexanone, trichloroethylene, perchloroethylene, ethyl acetate, amyl acetate, butyl acetate, propylene glycol monomethyl ether and diethylene glycol monomethyl ether, methyl alcohol, ethyl alcohol, isopropyl alcohol, amyl alcohol, ethylene glycol, propylene glycol, glycerine, N-methyl-2-pyrrolidinone, N,N-dimethyl alkylamides, dimethyl sulfoxide.

Solid carriers that may be employed in the compositions of the present invention may include but are not limited to attapulgite, pyrophyllite clay, silica, kaolin clay, kieselguhr, chalk, diatomaceous earth, lime, calcium carbonate, bentonite clay, Fuller's earth, talc, cottonseed hulls, wheat flour, soybean flour, pumice, wood flour, walnut shell flour, lignin, cellulose etc.

In accordance with an embodiment of the present invention, the surfactant can be selected from include non-ionic, anionic, cationic and ampholytic types such as alkoxylated fatty alcohols, ethoxylated polysorbate (e.g. tween 20), ethoxylated castor oil, lignin sulfonates, fatty acid sulfonates (e.g. lauryl sulfonate), phosphate esters such as phosphate esters of alcohol alkoxylates, phosphate esters of alkylphenol alkoxylates and phosphate esters of styrylphenol ethoxylates, condensates of sulfonated naphthalene and naphthalene derivatives with formaldehyde, condensates of naphthalene or of naphthalenesulfonic acid with phenol and formaldehyde, alkylarylsulfonates, ethoxylated alkylphenols and aryl phenols, polyalkylene glycols and sorbitol esters.

In yet another embodiment, the composition may be employed in any conventional form, for example, in the form of a twin pack, or as emulsion concentrates (EC), microemulsion concentrates (MEC), suspension concentrates (SC), soluble concentrates (SL), suspoemulsion (SE), oil dispersions (OD), water dispersible granules (WDG), water soluble granules (SG) and wettable powders (WP). Such compositions can be formulated using with agriculturally acceptable carriers, surfactants or other application-promoting adjuvants customarily employed in formulation technology and formulation techniques that are known in the art

In accordance with an embodiment of the present invention, the formulation as disclosed herein is a synergistic and stable microemulsion, wettable granule or powder formulation (WDG or WG) or emulsifiable concentrate.

The mixtures and/or the herbicidal compositions may be applied pre-plant incorporated, pre- or post-emergence.

In accordance with an embodiment of the present invention, the formulation as disclosed herein by way of one or more embodiments is capable of being employed in an amount that does not cause phytotoxic damage to any part of the main crop plant and wherein the formulation is safe.

EXPERIMENTAL: The invention is now illustrated by the following, non-limiting examples.

The various treatments that were prepared are illustrated below:

| | | Dose | |
|---|---|---|---|
| Treatments | | ml/gm/ha | gram ai/ha |
| T1 | Metamifop 10% EC | 900 | 90 |
| T2 | Metamifop 10% EC | 800 | 80 |
| T3 | Imazethapyr 10% SL | 753.75 | 75.375 |
| T4 | Imazethapyr 10% SL | 500 | 50 |
| T5 | Imazethapyr 10% SL | 400 | 40 |
| T6 | Imazethapyr 10% SL | 350 | 35 |
| T7 | Imazamox 70% WG | 50 gm | 35 |
| T8 | Imazamox 70% WG | 42.5 gm | 30 |
| T9 | Imazamox 70% WG | 27.5 gm | 20 |
| T10 | Metamifop 10% EC + | 800 + 50 | 80 + 35 |
| | Imazamox 70% WG | | |
| T11 | Metamifop 8% + Imazethapyr | 1125 | 90 + 75.375 |
| | 6.7% ME | | |
| T12 | Imazethapyr 10% SL + | 100 | 35 + 35 |
| | Imazamox 70% WG | | |
| T13 | Metamifop 8% + Imazethapyr | 1000 | 80 + 40 + 30 |
| | 4% + Imazamox 3% ME | | |
| T14 | Metamifop 8% + Imazethapyr | 1000 | 80 + 50 + 20 |
| | 5% + Imazamox 2% ME | | |
| T15 | Control | | |

### Example 1: Composition 1 of Microemulsion

| | Qty |
|---|---|
| INGREDIENTS | % w/w |
| Metamifop A.I | 1 to 30% |
| Imazethapyr A.I | 0.5 to 20% |
| Imazamox A.I | 0.1 to 25% |
| Sodium hydroxide/Potassium hydroxide (Inorganic alkali | 0.1 to 10% |
| compounds) | |
| Organic Solvent form the group of Aromatic ketones/glycol | 2 to 50% |
| ether/alcohols/glycols etc/solvent naphtha aromatic | |
| hydrocarbons. | |
| Ethoxylated polyarylphenol phosphate amine salt/tristryl | 1 to 40% |
| phenol phosphate potassium salts or any proprietary blend | |
| of surfactants. | |
| Ethoxylated tristyrylphenol | 0.5 to 30% |
| Branched calcium dodecyl benzene sulphonates | 0.1 to 20% |
| solvent naphtha aromatic hydrocarbons | 0.01-25% |
| Polysorbates Tween 20 | 0.01-50 |
| Benzenesulfonic acid, hydroxy-, polymer with | 0.01-10% |
| formaldehyde, phenol and urea, sodium salts | |
| Distilled water | QS |

### Example 2: Composition 2 of Microemulsion

| | Qty |
|---|---|
| INGREDIENTS | % w/w |
| Metamifop A.I | 1 to 30% |
| Imazethapyr A.I | 0.5 to 20% |
| Imazamox A.I | 0.1 to 25% |
| Sodium hydroxide/Potassium hydroxide (Inorganic alkali | 0.1 to 10% |
| compounds) | |
| Organic Solvent form the group of Aromatic ketones/glycol | 2 to 50% |
| ether/alcohols/glycols etc. | |
| Ethoxylated tristyrylphenol | 0.5 to 30% |
| Branched calcium dodecyl benzene sulphonates | 0.1 to 20% |
| Solvent naphtha aromatic hydrocarbons | 0.01-20% |
| Propylene Glycols | 0.01 to 40% |
| Polysorbates Tween 20 | 0.01-50 |
| Benzenesulfonic acid, hydroxy-, polymer with | 0.01-10% |
| formaldehyde, phenol and urea, sodium salts | |
| Distilled water | QS |

Preparation of Microemulsions: A three-way combination was formulated using above defined dispersing and wetting agent cum emulsifiers to form a stable micro emulsion. An Aqueous solution was prepared of Imazethapyr & Imazamox in alkaline media and phosphate based inorganic salt as stabilizer. Second phase was prepared by hydrophobic active ingredient (Metamifop) using Co-solvent from the group of glycol ether or aromatic ketones/alcohols glycols etc. etc. Here ethoxylate of polyarylphenol phosphate amine salts was used as a dispersing agent along with another defined emulsifier wetting/dispersing agents. Both phases are combined and mixed under share mixing to form a stable micro emulsion; water was used as QS.

### Example 3: Composition 3 of Wettable Granules/Powders

| INGREDIENTS | QUANTAITY % w/w |
|---|---|
| Metamifop A.I | 1 to 80 |
| Imazethapyr A.I | 0.5 to 70 |
| Imazamox A.I | 0.1 to 50 |
| Dispersing agent/proprietary blends | 0.1 to 10 |
| Wetting agent/proprietary blends | 2 to 50 |
| Ammonium sulphates/urea | 1 to 40 |
| China clay/silica | QS to make 100% w/w |

Preparation of Wettable Granules/powders: All the ingredients are weighed and milled through ACM/Jet milled to make wettable powder. This micronized powder mixed with suitable quantity of water to make dough for granulation and dried in Fluid Bed Dryer.

### Example 4: Composition 3 of Emulsifiable Concentrate

| INGREDIENTS | QUANTAITY % w/w |
|---|---|
| Metamifop A.I | 1 to 40 |
| Imazethapyr A.I | 0.5 to 30 |
| Imazamox A.I | 0.1 to 35 |
| Emulsifiers/proprietary blends | 0.1 to 10 |
| Other Additives | 2 to 10 |
| Solvents | QS to make 100% w/w |
| Co-Solvents | 2-30% |

EFFICACY STUDY: The field experiments were carried out to test the synergy of the combination Metamifop, Imazethapyr, and Imazamox in India at various locations like in MP, Maharashtra, Karnataka, and Telangana on farmer's field against soybean weeds during Kharif season. The experiment comprising of 15 treatments including premixed binary and ternary combinations along with their stand-alone molecule using a randomized block design replicated thrice. All the treatments were applied as post-emergence foliar application when the weeds reached to two to four leaf stage. The spray was conducted with the help of Battery-operated Knapsack sprayer. The percentage efficacy was calculated after 14 and 21 days after application of herbicides.

The weeds present in the experimental fields were echinochloa conola, echinochloa crusgalli, brachiaria euriciformis, rottboellia cochinchinensis, cynodon dactylon, parthenium hyterophorus, digera arvensis, cynotis axillaris, acalypha indica, Commelina benghalensis, celosia argentia, cyperus spp.

The herbicide premix and tank mix combinations, application rates, hard to kill weed spp were tested, and results are given in the following tables:

TABLE 1
Synergistic activity of herbicidal compositions on key grass weeds in Soybean at 14 days after application:

| | | | % Weed control burn down symptoms generation on different | | | | | |
|---|---|---|---|---|---|---|---|---|
| | | | weeds species at 14 DAA (Days per application) | | | | | |
| Dose | | | Echinochloa | | Brachiaria | | Rottboellia | |
| Application Rate gm ai/ha | | | crusgalli | | eruciformis | | cochinchinensis | |
| Metamifop | Imazethapyr | Imazamox | Observed | Expected | Observed | Expected | Observed | Expected |
| 90 | 0 | 0 | 83 | | 88 | | 70 | |
| 80 | 0 | 0 | 80 | | 84 | | 67 | |
| 0 | 75.375 | 0 | 20 | | 22 | | 30 | |
| 0 | 50 | 0 | 18 | | 20 | | 25 | |
| 0 | 40 | 0 | 18 | | 10 | | 0 | |
| 0 | 35 | 0 | 15 | | 8 | | 0 | |
| 0 | 0 | 35 | 0 | | 0 | | 0 | |
| 0 | 0 | 30 | 0 | | 0 | | 0 | |
| 0 | 0 | 20 | 0 | | 0 | | 0 | |
| 80 | 0 | 35 | 78 | | 88 | | 74 | |
| 90 | 75.375 | 0 | 87 | 86.4 | 91 | 91 | 83 | 79 |
| 0 | 35 | 35 | 55 | | 65 | | 43 | |
| 80 | 40 | 30 | 94 | 83.6 | 95 | 86 | 92 | 67 |
| 80 | 50 | 20 | 92 | 83.6 | 93 | 87 | 90 | 75 |

Result: The results in table 1 clearly demonstrates synergy at 14 days when the combination of Metamifop, Imazethapyr and Imazamox was used against above hard to kill grassy weeds. The difference between the observed and the expected efficacy clearly shows the synergistic effect of binary and ternary combination for longer duration. No phytotoxicity was observed on the wheat crop.

TABLE 2
Synergistic activity of herbicidal compositions on key grass weeds in Soybean at 21 days after application

| | | | % Weed control burn down symptoms generation on different | | | | | |
|---|---|---|---|---|---|---|---|---|
| | | | weeds species at 21 DAA | | | | | |
| Dose | | | Echinochloa | | Brachiaria | | Rottboellia | |
| Application Rate gm ai/ha | | | crusgalli | | eruciformis | | cochinchinensis | |
| Metamifop | Imazethapyr | Imazamox | Observed | Expected | Observed | Expected | Observed | Expected |
| 90 | 0 | 0 | 77 | | 81 | | 72 | |
| 80 | 0 | 0 | 74 | | 78 | | 70 | |
| 0 | 75.375 | 0 | 18 | | 15 | | 0 | |
| 0 | 50 | 0 | 16 | | 0 | | 0 | |
| 0 | 40 | 0 | 12 | | 0 | | 0 | |
| 0 | 35 | 0 | 8 | | 0 | | 0 | |
| 0 | 0 | 35 | 0 | | 0 | | 0 | |
| 0 | 0 | 30 | 0 | | 0 | | 0 | |
| 0 | 0 | 20 | 0 | | 0 | | 0 | |
| 80 | 0 | 35 | 76 | | 90 | | 75 | |
| 90 | 75.375 | 0 | 83 | 81.1 | 85 | 81 | 81 | 72 |
| 0 | 35 | 35 | 50 | | 64 | | 46 | |
| 80 | 40 | 30 | 97 | 77.1 | 98 | 78 | 90 | 69.7 |
| 80 | 50 | 20 | 94 | 78.1 | 96 | 78 | 87 | 69.7 |

Results: The results in table 2 clearly demonstrates synergy at 21 days when the combination of Metamifop, Imazethapyr and Imazamox was used against above hard to kill grassy weeds. The difference between the observed and the expected efficacy clearly shows the synergistic effect of binary and ternary combination.

TABLE 3
Synergistic activity of herbicidal compositions on key broad
leaf weeds in Soybean at 14 days after application

| | | | % Weed control burn down symptoms generation on different | | | | | |
|---|---|---|---|---|---|---|---|---|
| | | | weeds species at 14 DAA | | | | | |
| Dose | | | Parthenium | | Commelina | | Cyanotis | |
| Application Rate gm ai/ha | | | hysterophorus | | benghalensis | | axillaris | |
| Metamifop | Imazethapyr | Imazamox | Observed | Expected | Observed | Expected | Observed | Expected |
| 90 | 0 | 0 | 0 | | 0 | | 0 | |
| 80 | 0 | 0 | 0 | | 0 | | 0 | |
| 0 | 75.375 | 0 | 28 | | 56 | | 0 | |
| 0 | 50 | 0 | 11 | | 35 | | 447 | |
| 0 | 40 | 0 | 6 | | 22 | | 25 | |
| 0 | 35 | 0 | 0 | | 6 | | 12 | |
| 0 | 0 | 35 | 0 | | 6 | | 0 | |
| 0 | 0 | 30 | 0 | | 4 | | 0 | |
| 0 | 0 | 20 | 0 | | 0 | | 0 | |
| 80 | 0 | 35 | 0 | | 29 | | 0 | |
| 90 | 75.375 | 0 | 68 | 28 | 78 | 56 | 86 | 47 |
| 0 | 35 | 35 | 40 | | 76 | | 60 | |
| 80 | 40 | 30 | 79 | 6 | 87 | 25 | 97 | 12 |
| 80 | 50 | 20 | 74 | 11 | 84 | 35 | 90 | 25 |

Results: The results in table 3 clearly demonstrates synergy at 14 days when the combination of Metamifop, Imazethapyr and Imazamox was used against above hard to kill broad leaf weeds. The difference between the observed and the expected efficacy clearly shows the synergistic effect of binary and ternary combination. Alone Metamifop, Imazathapyr and Imazamox has shown no or very less control on targeted weeds, whereas binary and ternary premix combination has controlled the weeds synergistically.

TABLE 4
Synergistic activity of herbicidal compositions on key broad
leaf weeds in Soybean at 21 days after application

| | | | % Weed control burn down symptoms generation on different | | | | | |
|---|---|---|---|---|---|---|---|---|
| | | | weeds species at 21 DAA | | | | | |
| Dose | | | Parthenium | | Commelina | | Cyanotis | |
| Application Rate gm ai/ha | | | hysterophorus | | benghalensis | | axillaris | |
| Metamifop | Imazethapyr | Imazamox | Observed | Expected | Observed | Expected | Observed | Expected |
| 90 | 0 | 0 | 0 | | 0 | | 0 | |
| 80 | 0 | 0 | 0 | | 0 | | 0 | |
| 0 | 75.375 | 0 | 15 | | 45 | | 36 | |
| 0 | 50 | 0 | 6 | | 20 | | 20 | |
| 0 | 40 | 0 | 4 | | 13 | | 7 | |
| 0 | 35 | 0 | 0 | | 0 | | 0 | |
| 0 | 0 | 35 | 0 | | 0 | | 0 | |
| 0 | 0 | 30 | 0 | | 0 | | 0 | |
| 0 | 0 | 20 | 0 | | 0 | | 0 | |
| 80 | 0 | 35 | 0 | | 20 | | 0 | |
| 90 | 75.375 | 0 | 69 | 15 | 80 | 45 | 80 | 36 |
| 0 | 35 | 35 | 40 | | 77 | | 67 | |
| 80 | 40 | 30 | 80 | 4 | 89 | 13 | 98 | 7 |
| 80 | 50 | 20 | 76 | 6 | 85 | 20 | 93 | 20 |

Results: The results in table 3 clearly demonstrates synergy at 21 days when the combination of Metamifop, Imazethapyr and Imazamox was used against above hard to kill broad leaf weeds. The difference between the observed and the expected efficacy clearly shows the synergistic effect of binary and ternary combination. Alone Metamifop, Imazathapyr and Imazamox has shown no or very less control on targeted weeds, whereas binary and ternary premix combination has controlled the weeds synergistically for longer duration. The combination was not found to be phytotoxic to the wheat crop.

Phytotoxic effect of herbicidal combination of Metamifop, Imazethapyr and Imazamox in soyabean: Table 5, 10 show the visual observations and grading on phytotoxicity which was recorded for leaf injury on tip/surface, Epinasty/Hyponasty, and wilting etc. on 0-10 scale (as below) at 1, 3, 7, 14 and 21 days after application of the present herbicidal composition.

| Scale or Score | Phytotoxicity (Percent) |
|---|---|
| 0 | No Phytotoxicity |
| 1 | 1-10 |
| 2 | 11-20 |
| 3 | 21-30 |
| 4 | 31-40 |
| 5 | 41-50 |
| 6 | 51-60 |
| 7 | 61-70 |
| 8 | 71-80 |
| 9 & 10 | Complete destruction |

TABLE 6
Effect of herbicidal composition on the Phytotoxicity in Soybean

| Dose | | | Phytotoxicity score | | | | |
|---|---|---|---|---|---|---|---|
| Application Rate gm ai/ha | | | Days after herbicides application | | | | |
| Metamifop | Imazethapyr | Imazamox | 1 DAA | 3 DAA | 7 DAA | 14 DAA | 21 DAA |
| 90 | 0 | 0 | 0 | 0 | 0 | 0 | 0 |
| 80 | 0 | 0 | 0 | 0 | 0 | 0 | 0 |
| 0 | 75.375 | 0 | 0 | 0 | 0 | 0 | 0 |
| 0 | 50 | 0 | 0 | 0 | 0 | 0 | 0 |
| 0 | 40 | 0 | 0 | 0 | 0 | 0 | 0 |
| 0 | 35 | 0 | 0 | 0 | 0 | 0 | 0 |
| 0 | 0 | 35 | 0 | 0 | 0 | 0 | 0 |
| 0 | 0 | 30 | 0 | 0 | 0 | 0 | 0 |
| 0 | 0 | 20 | 0 | 0 | 0 | 0 | 0 |
| 80 | 0 | 35 | 0 | 0 | 0 | 0 | 0 |
| 90 | 75.375 | 0 | 0 | 0 | 0 | 0 | 0 |
| 0 | 35 | 35 | 0 | 0 | 0 | 0 | 0 |
| 80 | 40 | 30 | 0 | 0 | 0 | 0 | 0 |
| 80 | 50 | 20 | 0 | 0 | 0 | 0 | 0 |

| | | | | | |
|---|---|---|---|---|---|
| Control | 0 | 0 | 0 | 0 | 0 |

0=No phytotoxicity: There was no Phytotoxicity or crop injury or burning of leaves etc. at higher concentrations of treatments as shown in the table no. 6. The binary and ternary combination are safe for soybean crop at applied doses.

The foregoing descriptions of exemplary embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated. It is understood that various omissions, substitutions of equivalents are contemplated as circumstance may suggest or render expedient, but is intended to cover the application or implementation without departing from the spirit or scope of the claims of the present invention.

1. A herbicidal composition comprising:
i) Metamifop;
ii) a member of Imidazoline family;
wherein the member of Imidazoline family is selected from imazethapyr or imazamox or combinations thereof, and
iii) an agriculturally acceptable adjuvant;
wherein a weight ratio of Metamifop and the member of Imidazolinone family is within the range from 2:80 to 80:2

2. (canceled)

3. The composition as claimed in claim 1, wherein Metamifop is present in an amount ranging from 2 to 80% w/w based on the total weight of the composition.

4. The composition as claimed in claim 1, wherein the member of Imidazoline family is present in an amount ranging from 0.1 to 80% w/w based on the total weight of the composition.

5. The composition as claimed in claim 1, wherein the member of Imidazoline family is an ammonium salt.

6. The composition as claimed in claim 1, further comprising a surfactant selected from the group consisting of: non-ionic, anionic, cationic and ampholytic types such as alkoxylated fatty alcohols, ethoxylated polysorbate (e.g. tween 20), ethoxylated castor oil, lignin sulfonates, fatty acid sulfonates (e.g. lauryl sulfonate), phosphate esters such as phosphate esters of alcohol alkoxylates, phosphate esters of alkylphenol alkoxylates and phosphate esters of styrylphenol ethoxylates, condensates of sulfonated naphthalene and naphthalene derivatives with formaldehyde, condensates of naphthalene or of naphthalenesulfonic acid with phenol and formaldehyde, alkylarylsulfonates, ethoxylated alkylphenols and aryl phenols, polyalkylene glycols and sorbitol esters.

7. The composition as claimed in claim 6, wherein said surfactants are present in an amount ranging from about 30%-50% w/w based on the total weight of the emulsion concentrate.

8. (canceled)

9. (canceled)

10. (canceled)

11. (canceled)
